(19) United States
(12) Patent Application Publication
(10) Pub. No.: US 2024/0095709 A1
(43) Pub. Date: Mar. 21, 2024

(54) MULTI-BATCH SELF-CHECKOUT SYSTEM AND METHOD OF USE

(71) Applicant: Mashgin Inc., Palo Alto, CA (US)

(72) Inventors: Abhinai Srivastava, Palo Alto, CA (US); Mukul Dhankhar, Palo Alto, CA (US)

(21) Appl. No.: 17/945,912

(22) Filed: Sep. 15, 2022

(51) Int. Cl. G06Q 20/20; G06Q 20/14; G06Q 20/18; G06Q 30/04; G06V 10/26; G06V 10/74; G06V 10/764; G06V 10/82; G06V 20/50

(52) U.S. Cl. CPC G06Q 20/208; G06Q 20/14; G06Q 20/18; G06Q 30/04; G06V 10/26; G06V 10/761; G06V 10/764; G06V 10/82; G06V 20/50

(57) ABSTRACT

In variants, the self-checkout method can include: acquiring measurements of a batch of items, automatically identifying each item based on the measurements, and repeating the above until a checkout condition is met.

### TECHNICAL FIELD

This invention relates generally to the computer vision field, and more specifically to a new and useful system and method for item recognition from scenes.

### BRIEF DESCRIPTION OF THE FIGURES

FIG. 1 depicts a schematic representation of a variant of the method.

FIG. 2 depicts a schematic representation of a variant of method.

FIG. 3 depicts a schematic representation of a variant of the system.

FIG. 4 depicts an example of the system.

FIG. 5 depicts an example of the imaging system.

FIG. 6 depicts an example of S100.

FIG. 7 depicts a flowchart diagram of a variant of the method.

FIG. 8 depicts an illustrative representation of an example of the method.

FIG. 9 depicts an example of S370 wherein 3 image segments are determined for the same item based on the convex hull of the item and the associated color image for each respective camera.

FIG. 10 depicts an example of S330.

FIG. 11 depicts a variant of S390.

FIG. 12 depicts a variant of identifying the items based on the measurements.

FIG. 13 depicts a schematic example of iteratively identifying the items within the batch while a checkout condition is not met and/or while an addition condition is met.

FIGS. 14A and 14B depict an illustrative example of iteratively identifying batch items until a checkout condition is met.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. OVERVIEW

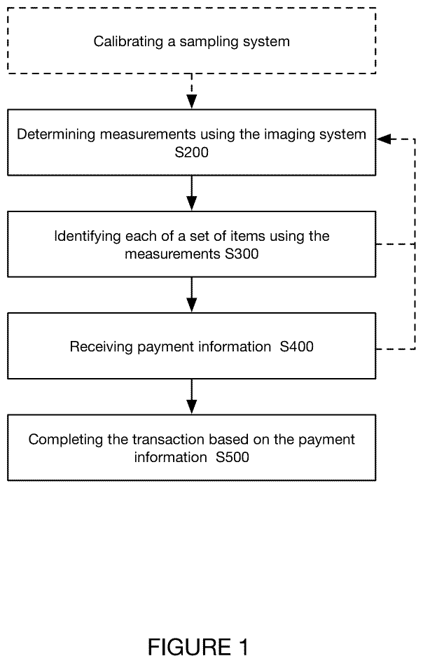

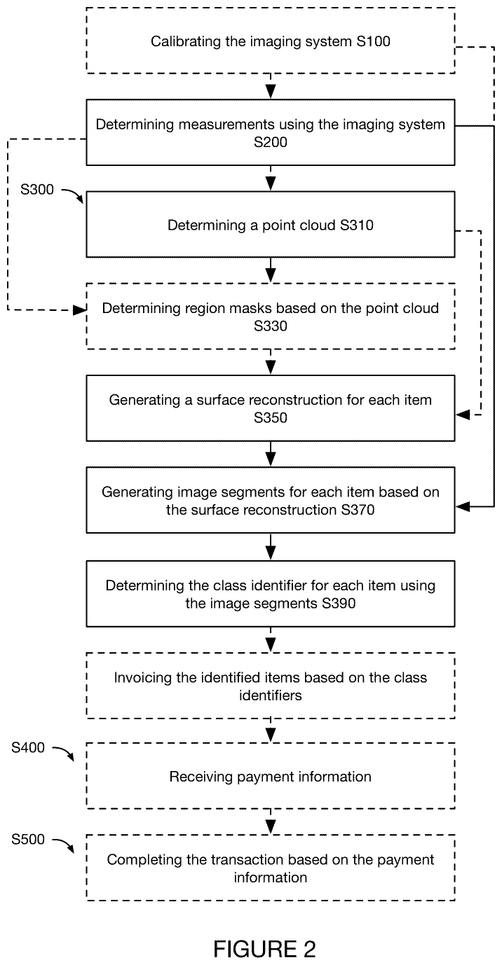

As shown in FIG. 1, the method for item recognition can include: optionally calibrating a sampling system S100, determining measurements using the sampling system S200, identifying each of a set of items using the measurements S300, receiving payment information S400, and completing the transaction based on the payment information S500.

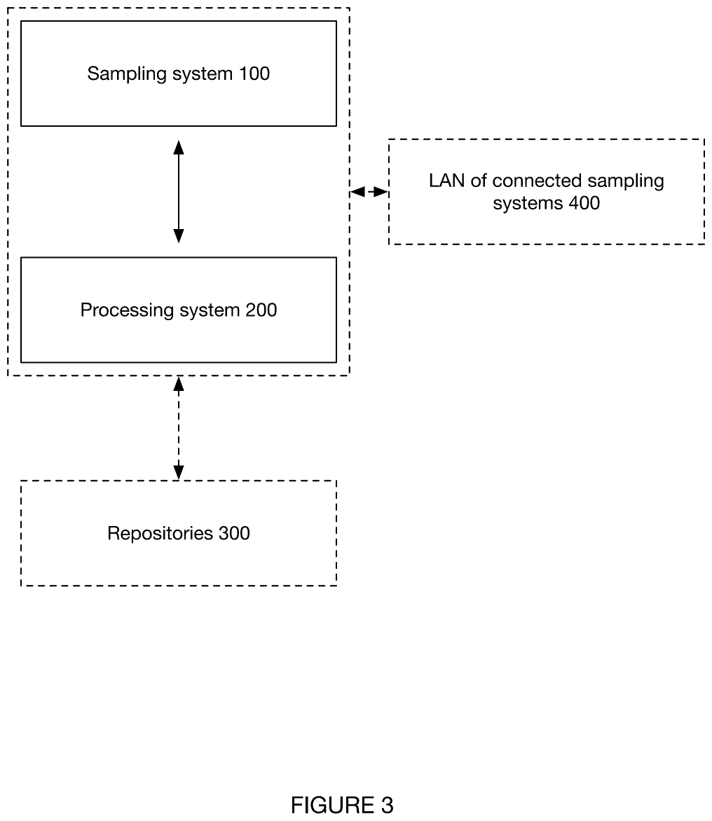

As shown in FIG. 3, the system for item recognition can include: a sampling system 100, a processing system 200, optionally one or more repositories 300, optionally a local area network 400, and/or any other suitable components.

In variants, the technology can use the systems and/or methods disclosed in U.S. application Ser. No. 17/246,409 filed 30 Apr. 2021, which is a continuation of U.S. application Ser. No. 17/113,757, filed 7 Dec. 2020, which claims the benefit of U.S. Provisional Application Ser. No. 62/945,032, filed on 6 Dec. 2019, each of which are incorporated in their entireties by this reference.

In variants, the technology can use the systems and/or methods disclosed in U.S. application Ser. No. 17/323,943 filed 18 May 2021, which is a continuation-in-part of U.S. application Ser. No. 17/079,056, filed 23 Oct. 2020, which claims the benefit of U.S. Provisional Application Ser. No. 62/926,296, filed on 25 Oct. 2019, each of which are incorporated in their entireties by this reference.

In variants, the technology can use the systems and/or methods disclosed in U.S. application Ser. No. 17/129,296 filed 21 Dec. 2020, which is a continuation in part of U.S. application Ser. No. 16/168,066 filed 23 Oct. 2018, which is a continuation of U.S. application Ser. No. 14/517,634, filed 17 Oct. 2014, which claims the benefit of U.S. Provisional Application No. 61/891,902 filed 17 Oct. 2013, each of which are incorporated in their entireties by this reference.

In variants, the technology can use the systems and/or methods disclosed in U.S. application Ser. No. 17/667,279 filed 8 Feb. 2022, which is a continuation of U.S. patent application Ser. No. 16/923,674 filed 8 Jul. 2020, which is a continuation of U.S. patent application Ser. No. 15/685,455 filed 24 Aug. 2017, which is a continuation-in-part application of U.S. patent application Ser. No. 15/497,730, filed on Apr. 26, 2017, each of which is incorporated by reference in their entireties by this reference.

### 2. EXAMPLES

In a first example, the method can include: determining a set of images of a set of items; generating a point cloud using the set of images; determining a height map using the point cloud; determining a region mask for each item using a segmentation classifier that ingests the height map as input; generating a coarse mesh for each item using the region mask and, optionally, the height map; determining an image segment for each item by projecting the respective coarse mesh into a camera frame for each image; determining a class identifier for each item using the image segments; and optionally invoicing the identified items based on the class identifiers.

In this example, the method can optionally include determining a calibration matrix for each camera and using the respective calibration matrix to generate the point cloud and/or project the coarse mesh into the respective camera frame.

### 3. BENEFITS

The method confers several benefits over conventional systems.

First, the method can improve item segmentation and identification accuracy by leveraging 3D visual data instead of processing only 2D data. For example, a point cloud can be used to determine the item contours in each image frame for 2D image segmentation of each item in the scene. In a second example, both 2D image segments and 3D geometric segments can be used to identify the item.

Second, in some variants, the method can segment images faster and/or more efficiently than conventional systems. This can be accomplished by leveraging height maps (e.g., based on a top-down view of the point cloud) to: segment the volumetric space (e.g., the 3D space, the point cloud), generate the region masks, and/or generate the surface reconstruction (e.g., by projecting a resultant region mask downward to generate a convex hull, instead of attempting to identify an item's side contours). The inventors have discovered that, in commercial applications, a top-down view can be sufficient to segment checkout items, because users oftentimes do not stack items on top of each other (and/or the items are oddly shaped and do not stack well). The height map can increase segmentation and/or masking speed by reducing the number of 3D points to process—in examples, using the height map (e.g., instead of the point cloud) can reduce the number of 3D points to process by 80-90%. To further increase speed, in some variants, the point cloud is quantized before generating the height map, which can further reduce the information to be processed at segmentation.

Third, in some variants, the technology can increase usability by allowing multiple batches of items to be included in a single transaction or checkout session. The inventors have discovered that this can be particularly useful when: a single user is paying for the items for group of users (e.g., a parent is paying for a family, wherein each family member has their own batch of items or own tray of food), when the user wants to purchase more items than will simultaneously fit within the measurement volume, and/or in other situations. Multi-batch checkout can be difficult because, in variants, the measurement volume is static and can only fit a limited volume of items—it can be difficult to determine when a transaction or checkout system should be ended. In variants, the technology can enable multi-batch checkout by accruing the charges for multiple sets of items (e.g., multiple batches of items) against the same invoice and completing the transaction when a checkout confirmation is determined. In variants, the payment information can be received before all items have been identified and stored for final payment (e.g., after all items have been identified). Examples of checkout confirmations can include: explicit selection of a checkout button, nonindication that additional item batches will be forthcoming, nondetection of an item partially located within the measurement volume, and/or other checkout confirmations.

However, variants of the technology can confer any other suitable benefits and/or advantages.

### 4. SYSTEM

The method is preferably performed using a system 20, including: one or more sampling systems 100, and one or more processing systems 200, optionally one or more repositories 300, optionally a local area network 400, and/or any other components.

The sampling system 100 functions to sample images of the items. The items can include: consumables, durables, and/or any other suitable item (e.g., commercial item). The items can have or lack semantic identifiers. Examples of semantic identifiers can include machine-readable identifiers, human-readable identifiers, and/or any other suitable readable identifier. Specific examples of semantic identifiers can include: barcodes (e.g., QR codes, line barcodes, UPCs, etc.), NFC tags, alphanumeric text (e.g., labels, logos, etc.), any other suitable identifier. Examples of items can include: clothing, shoes, prepared food (e.g., hot food, plates of food, etc.), packaged food (e.g., cans, tins, bags, etc.), and/or any other item.

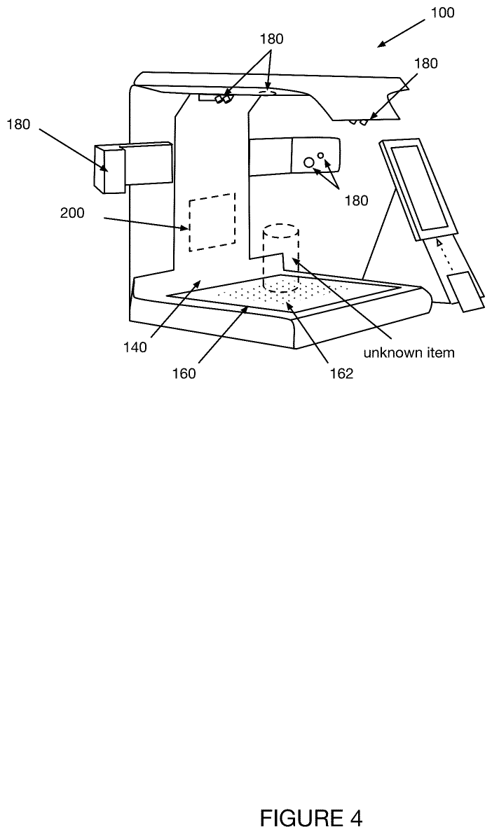

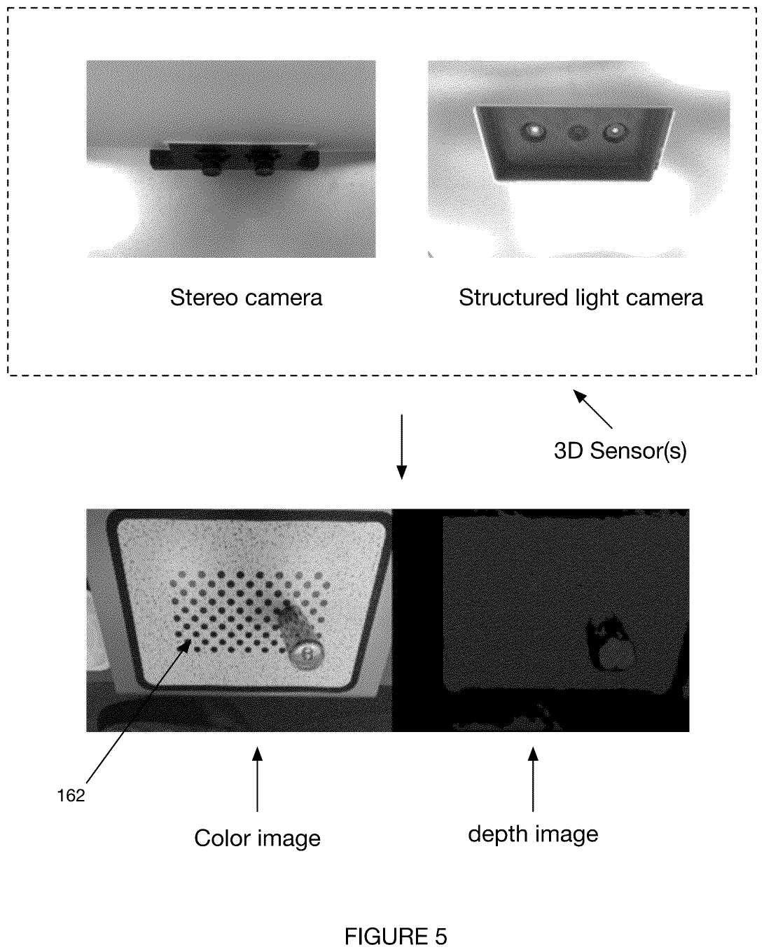

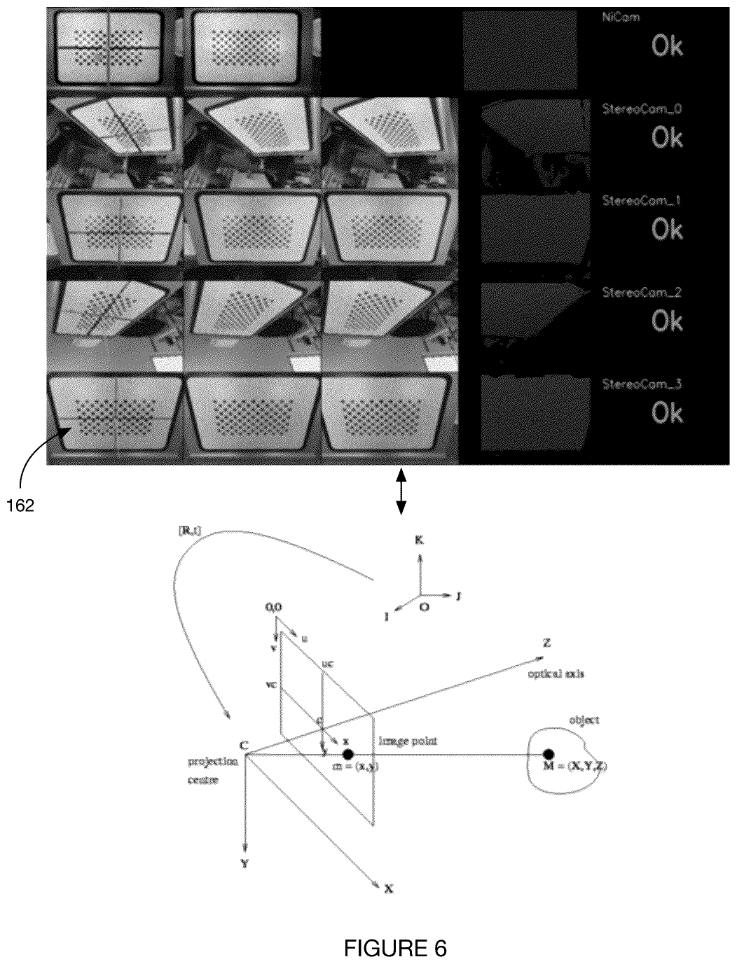

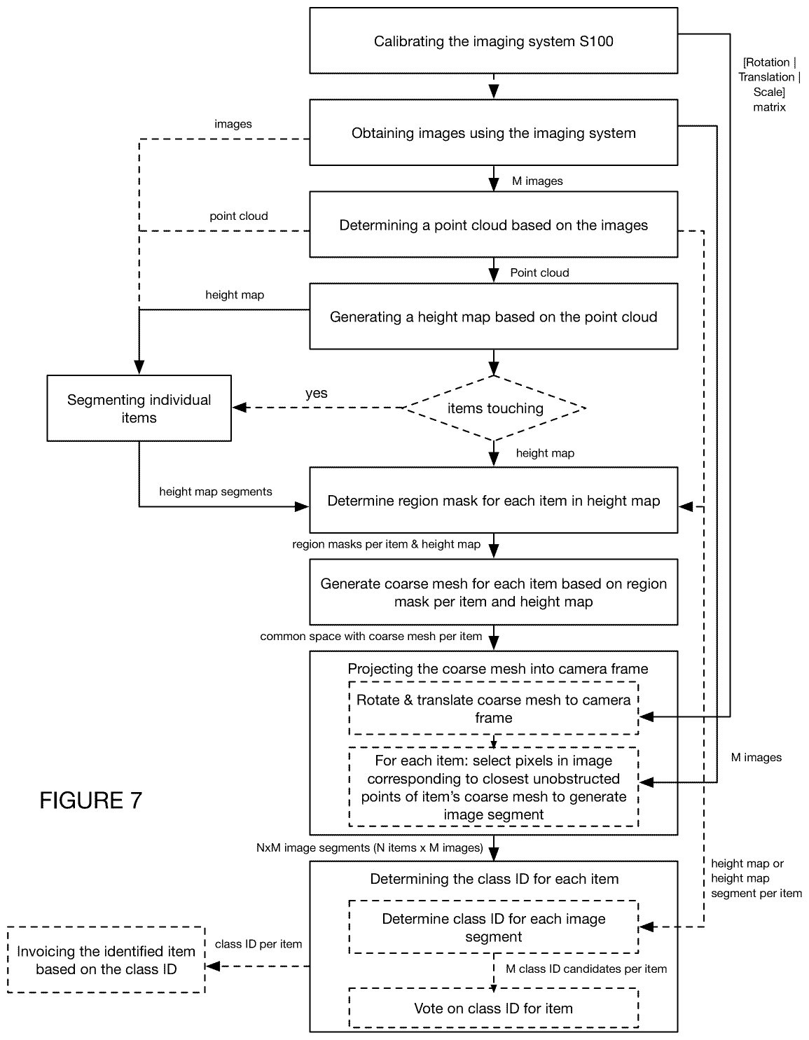

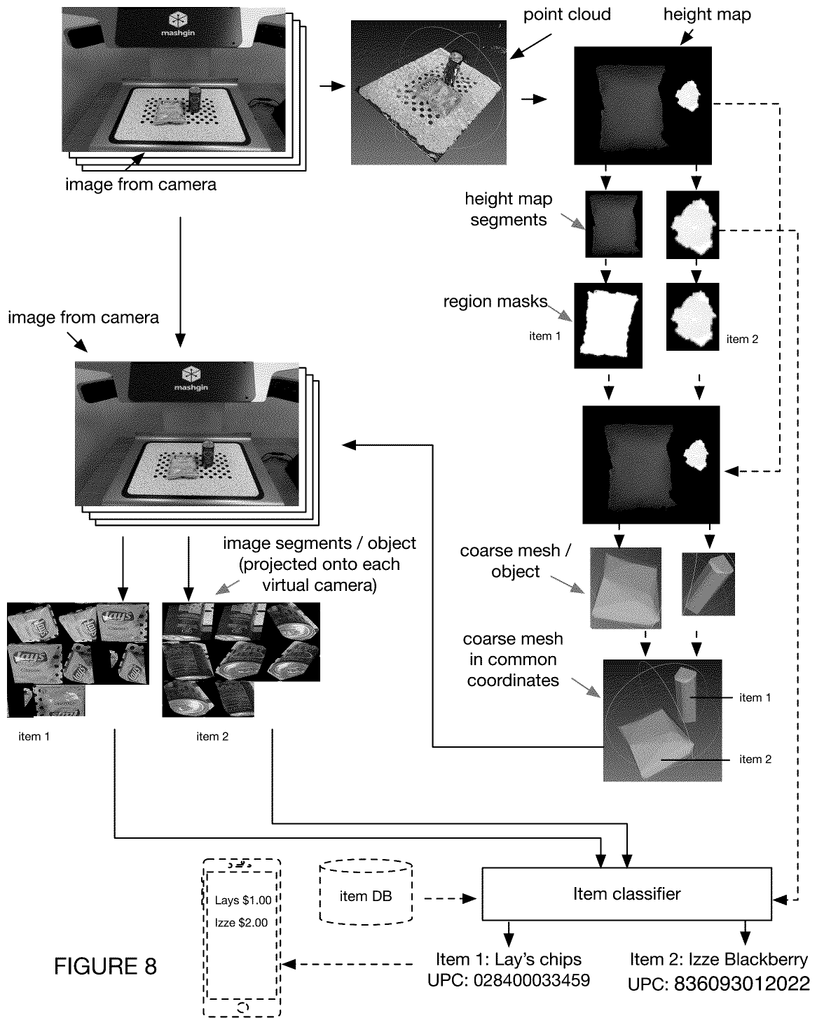

The sampling system can include: a housing 120 defining a measurement volume 140, and a set of sensors 180 monitoring the measurement volume 140 (e.g., shown in FIG. 4). The sampling system 100 is preferably located at the edge (e.g., onsite at a user facility), but can alternatively be located in another venue.

The sampling system can be a retrofit system, a stand-alone system, an installation, and/or be otherwise configured relative to its environment. In a first variant, the sampling system 100 can be built into or be recessed into a countertop or other support surface. In examples, the base 160 can be built into, be made from, or be recessed into the surrounding support surface, such that the base 160 is substantially flush with the support surface. In a second variant, the sampling system 100 can sit on top of the support surface. However, the sampling system can be otherwise arranged relative to its environment.

The housing 120 of the sampling system functions to define the measurement volume 140 (e.g., measurement volume), and can optionally retain the sensors in a predetermined configuration about the measurement volume. The measurement volume 140 is preferably static (e.g., static relative to the housing, static relative to an ambient environment, etc.), but can alternatively be dynamic (e.g., move in space, change in shape and/or volume, etc.). The measurement volume can be defined by the interior surfaces of the sampling system and/or housing (e.g., by the interior surfaces of the arms, base, and head), but can additionally or alternatively be defined by the region occupied by a set of items, the region configured to receive a set of items, and/or be otherwise defined.

The housing 120 can optionally define one or more item insertion regions (e.g., between housing walls, between housing arms, along the sides or top of the measurement volume, etc.) along one or more sides of the housing. The housing can include: a base 160 and one or more arms, wherein the measurement volume is defined between the base and arm(s).

The base 160 is preferably static relative to the arms and/or sensors, but can alternatively be mobile (e.g., be a conveyor belt).

The base preferably includes a calibration pattern, but can alternatively have no pattern, have a solid color (e.g., black), be matte, be reflective, or be otherwise optically configured. However, the base can be otherwise configured.

The calibration pattern 162 preferably functions to enable camera calibration for the imaging system (e.g., enables the system to determine the location of each camera with reference to a common coordinate system). The calibration pattern can be used to determine one or more calibration matrices for: a single camera, a stereocamera pair, and/or any other suitable optical sensor. The calibration matrices can be: intrinsic calibration matrices, extrinsic calibration matrix relating the camera to the measurement volume, extrinsic matrices relating the cameras to each other, and/or other calibration matrices. The calibration pattern is preferably arranged on (e.g., printed on, stuck to, mounted to, etc.) the base of the housing, but can alternatively be arranged along an interior wall, an arm, and/or otherwise arranged. The calibration pattern (or portions thereof) preferably appear in each optical sensor's field of view, but can alternatively appear in all RGB sensors' fields of view, a subset of the optical sensors' fields of view, and/or otherwise appear in the images. The calibration pattern is preferably axially asymmetric (e.g., along one or more axes, such as the x-axis, y-axis, etc.), but can alternatively be symmetric along one or more axes. The calibration pattern can be an array of shapes (e.g., circles, squares, triangles, diamonds, etc.), a checkerboard, an ArUco pattern, a ChArUco pattern, multiple CharuCo targets (e.g., arranged as a checkerboard, grid, etc.), a circle grid pattern, an image, a logo (e.g., of the merchant), and/or any other calibration pattern. The calibration pattern can include one or more colors (e.g., red, green, blue, and/or various shades or combinations) and/or be black and white. The parameters of the calibration pattern (e.g., shape size, shape arrangement, pattern alignment with the measurement volume's axes, pattern pose relative to the measurement volume, etc.) are preferably known, but can alternatively be unknown. The calibration can be raised (e.g., less than 1 mm, less than 2 mm, less than 5 mm, etc.) or smooth (e.g., planar). However, the calibration pattern can be otherwise configured.

The arms are preferably static, but can alternatively be actuatable. The arms can extend from the base (e.g., perpendicular to the base, at a non-zero angle to the base, etc.), extend from another arm (e.g., parallel the base, at an angle to the base, etc.), and/or be otherwise configured. The housing can optionally include a top, wherein the top can bound the vertical extent of the measurement volume and optionally control the optical characteristics of the measurement volume (e.g., by blocking ambient light, by supporting lighting systems, etc.). However, the housing can be otherwise configured.

The sensors 180 of the sampling system function to sample measurements of the items within the measurement volume. The sensors are preferably mounted to the arms of the housing, but can alternatively be mounted to the housing side(s), top, bottom, threshold (e.g., of the item insertion region), corners, front, back, and/or any other suitable portion of the housing. The sensors are preferably arranged along one or more sides of the measurement volume, such that the sensors monitor one or more views of the measurement volume (e.g., left, right, front, back, top, bottom, corners, etc.). The sensors can be arranged such that they collectively encompass a predetermined percentage of the measurement volume's points of view (e.g., greater than 20%, greater than 50%, greater than 70%, greater than 80%, etc.), which can provide more viewing angles for an unknown item, but can alternatively encompass a smaller proportion. The sensors can be arranged such that each imaging sensor's field of view encompasses the calibration pattern on the base of the housing, a portion of the calibration pattern (e.g., greater than 60%, greater than 70%, greater than 80%, etc.), none of the calibration pattern, and/or any other feature of the housing or portion thereof. In a specific example, the sensors are arranged along at least the left, right, back, and top of the measurement volume. However, the sensors can be otherwise arranged.

The sampling system preferably includes multiple sensors, but can alternatively include a single sensor. The sensor(s) can include: imaging systems, weight sensors (e.g., arranged in the base), acoustic sensors, touch sensors, proximity sensors, and/or any other suitable sensor. The imaging system functions to output one or more images of the measurement volume (e.g., image of the items within the measurement volume), but can additionally or alternatively output 3D information (e.g., depth output, point cloud, etc.) and/or other information. The imaging system can be a stereocamera system (e.g., including a left and right stereocamera pair), a depth sensor (e.g., projected light sensor, structured light sensor, time of flight sensor, laser, etc.), a monocular camera (e.g., CCD, CMOS), and/or any other suitable imaging system.

In a specific example, the sampling system includes stereocamera systems mounted to at least the left, right, front, and back of the measurement volume, and optionally includes a top-mounted depth sensor. In a second specific example, the sampling system can be any of the systems disclosed in U.S. application Ser. No. 16/168,066 filed 23 Oct. 2018, U.S. application Ser. No. 16/923,674 filed 8 Jul. 2020, U.S. application Ser. No. 16/180,838 filed 5 Nov. 2018, and/or U.S. application Ser. No. 16/104,087 filed 16 Aug. 2018, each of which is incorporated herein in its entirety by this reference. However, the sampling system can be otherwise configured.

The processing system 200 can function to process the set of images to determine the item class. All or a portion of the processing system is preferably local to the sampling system, but can alternatively be remote (e.g., a remote computing system), distributed between the local and remote system, distributed between multiple local systems, distributed between multiple sampling systems, and/or otherwise configured. The processing system preferably includes one or more processors (e.g., CPU, GPU, TPU, microprocessors, etc.). The processing system can optionally include memory (e.g., RAM, flash memory, etc.) or other nonvolatile computer medium configured to store instructions for method execution, repositories, and/or other data. When the processing system is remote or distributed, the system can optionally include one or more communication modules, such as long-range communication modules (e.g., cellular, internet, Wi-Fi, etc.), short range communication modules (e.g., Bluetooth, Zigbee, etc.), local area network modules (e.g., coaxial cable, Ethernet, WiFi, etc.), and/or other communication modules.

The system 20 can include one or more communication modules. (e.g., wireless communication module). The communication modules preferably function to transfer information between the sampling system and the remote computing system. For example, the information transmitted from the sampling system to the remote computing system can include a new or updated item classifier, a new item representation, or any other suitable information. In another example, the information transmitted from the remote computing system to the sampling system can include a new or updated item classifier from the plurality of sampling systems connected by the LAN 400. The communication modules can include long-range communication modules (e.g., supporting long-range wireless protocols), short-range communication modules (e.g., supporting short-range wireless protocols), and/or any other suitable communication modules. The communication modules can include cellular radios (e.g., broadband cellular network radios), such as radios operable to communicate using 3G, 4G, and/or 5G technology, Wi-Fi radios, Bluetooth (e.g., BTLE) radios, NFC modules (e.g., active NFC, passive NFC), Zigbee radios, Z-wave radios, Thread radios, wired communication modules (e.g., wired interfaces such as USB interfaces), and/or any other suitable communication modules.

The system can include one or more item repositories 300, which can store, for a set of identifiable items: one or more item identifiers (e.g., user-readable identifiers, SKU information, etc.); classification information (e.g., patterns, vectors, etc.); pricing; stock; purchase history; and/or any other suitable item information. The item repository can be populated and/or maintained by: a merchant, a central entity, and/or any other suitable entity.

The system can include one or more transaction repositories that function to store transaction information. Transaction information can include: the items purchased (e.g., identifiers thereof); the quantity of each item; the price per item; whether or not the item was identified; payment information (e.g., a transaction number, a hash of the credit card, etc.); the probability or confidence of item identification; the transaction timestamp; and/or any other suitable information generated during the transaction.

The system can optionally include one or more local area networks (LANs) 400 of connected systems. The LAN preferably functions to ensure information processing completed by a first sampling system is forwarded to other sampling systems connected by the LAN as opposed to completing information processing at all sampling systems. This preferred functionality can ensure reliability of sampling systems connected by the LAN (e.g., all machines are operating with the same items and same model), but can incur any other suitable benefit. The LAN can additionally or alternatively function to forward an item repository, or enable any other suitable function.

In one variation, a first kiosk in the LAN can function as the master, and the rest can function as slaves. The master can specify how data should be routed between the systems connected by the LAN or perform any other suitable set of functionalities.

In a second variation, the remote computing system can function as a router. The remote computing system can specify how data should be routed between the sampling systems connected by the LAN or perform any other suitable set of functionalities.

The system can optionally include or be used with one or more point of sale systems (POS system), which functions to receive, encrypt, confirm, and/or otherwise process payment for the transaction (e.g., invoice). Examples of payment forms accepted by the POS system can include: cash, credit, debit, store credit, cryptocurrency, and/or any other suitable form of payment. The POS system can include: a card reader (e.g., credit card reader, debit card reader, gift card reader, etc.), a cash register (e.g., a manual cash register, an automated cash register configured to calculate and return change, etc.), a barcode reader (e.g., camera, QR code reader, etc.), an NFC reader, an IC chip reader, and/or any other suitable reader or sensor. The POS system can be communicatively connected to the system (e.g., wirelessly connected, connected by a wire, etc.) or be otherwise connected to the system.

In variants, the POS system (and/or the system itself) can store payment information for a user. The payment information can include: a form of payment (e.g., cash, check, credit, debit, etc.), a card number, cardholder name, account number, expiration date, validation code, cryptographic signature (e.g., generated by the IC chip, the card issuer, etc.), a user identifier (e.g., biometrics, wireless tag, barcode, name, etc.), and/or any other suitable information. The payment information can be stored: until a checkout condition or payment event occurs, for a predetermined period of time (e.g., 10 minutes, 1 day, etc.), and/or for any other suitable time period. Examples of payment events can include: checkout confirmation detection, a predetermined period of time lapsing, credit card settlement, and/or any other suitable event. Alternatively, the payment information can not be stored.

However, the system can additionally or alternatively include any other suitable elements.

### 5. METHOD

The method for item recognition can include: optionally calibrating a sampling system S100, determining measurements using the sampling system S200, identifying each of a set of items using the measurements S300, receiving payment information S400, and completing the transaction based on the payment information S500, and/or other elements.

The method functions to automatically identify unknown items appearing within a measurement volume. The method can optionally automatically present checkout information for the identified items, automatically charge for the identified items, automatically decrement an inventory count for the identified (or purchased) items, automatically generate a transaction history for the identified items, otherwise automatically facilitate purchase of the items, or otherwise manage the identified items. In examples, this can enable automated checkout (e.g., self-checkout) without a cashier or other user in the loop.

All or a portion of the method can be performed in real- or near-real time (e.g., less than 100 milliseconds, less than 1 second, within 1 second, within 5 seconds, etc.), iteratively performed, be performed asynchronously or with any other suitable frequency, and/or be performed at any other time. All or portions of the method can be performed automatically, manually, and/or otherwise performed.

All elements or a subset of elements of the method are preferably performed by the system, but can additionally or alternatively be performed by any other suitable system.

### 5.1 Calibrating a Sampling System.

Calibrating a sampling system S100 can function to determine one or more calibration matrices (e.g., bi-directional mapping, unidirectional mapping, etc.) between a camera coordinate system and a common coordinate system for each camera of the imaging system. S100 is preferably performed before S200, but can additionally or alternatively be performed after (e.g., to update the calibration matrices for subsequent identification). S100 can be performed: before each identification session, periodically (e.g., at a predetermined frequency such as every minute, every 2 minutes, every 3 minutes, every 5 minutes, etc.), in response to determination that the system and/or a sensor is miscalibrated, or at any other suitable time. S100 can additionally or alternatively be performed at the factory, in situ (e.g., during operation, between operation sessions, such that the system is self-calibrating or self-healing), in real-time, during S200, and/or at any other suitable time.

The calibration matrices can be a coordinate transformation function. The calibration matrices can include rotation, translation, and scale information, and/or any other suitable information. The calibration matrices are preferably determined based on the calibration pattern (e.g., located on the base of the housing), but can be otherwise determined.

In a first variation, the calibration matrices are those described in U.S. application Ser. No. 15/685,455 filed 24 Aug. 2017, incorporated herein in its entirety by this reference.

In a second variation, calibrating the system can include triangulation, projective reconstruction and factorization, affine reconstruction and factorization, bundle adjustment and/or be otherwise calibrated.

In a third variation, calibrating the system can include: sampling an observation with each sensor; detecting a common calibration pattern (shared between the sensors) within the observation; and computing the transformation matrix based on the pose of the calibration pattern relative to the camera coordinate system. When the sensor is a color camera, the observation can be a color image and the calibration pattern can be a pattern (e.g., dot pattern, square pattern, etc.) arranged on the system base. When the sensor is a depth sensor, the observation can be a depth map and the calibration pattern can be a depth corresponding to the base (e.g., predetermined depth, predetermined number of depth points sharing a common depth, depth points that fit to a common plane, etc.). However, the system can be otherwise calibrated.

However, S100 can additionally or alternatively include any other suitable elements performed in any suitable manner. 5.2 Determining Measurements Using the Sampling System.

Determining measurements using the sampling system S200 can function to determine measurements of the measurement volume for item recognition. S200 is preferably performed after calibrating the sampling system, but can additionally or alternatively be performed contemporaneously or before. S200 is preferably performed after items are detected within a measurement volume and/or after a checkout session (e.g., transaction) is initiated, but can additionally or alternatively be performed contemporaneously, before, or at any other time. Items can be detected within the measurement volume: when the base or base pattern is occluded, when a motion sensor detects motion within the measurement volume, when a weight sensor connected to the base is triggered (e.g., the measured weight increases), when an item breaks a light beam or sheet extending across a measurement volume opening, and/or be otherwise detected. A transaction can be initiated when: an item is detected within the measurement volume, a user manually indicates transaction initiation (e.g., by selecting a button), a user is detected in front of the system 20, and/or be otherwise initiated.

S200 is preferably performed by the imaging system, wherein the imaging system includes a plurality of cameras (e.g., M cameras), but can additionally or alternatively be performed by any other suitable system. The plurality of cameras preferably include multiple stereo camera pairs and a structured light camera (e.g., as discussed above), but can additionally or alternatively include any other suitable cameras. Different cameras of the plurality preferably sample (e.g., take images of) the measurement volume contemporaneously or concurrently, but can sample the measurement volume sequentially (e.g., to minimize lighting interference), in parallel, in a predetermined order, or in any other order.

The measurements can be captured, acquired, sampled, retrieved, and/or otherwise determined. The measurements are preferably captured while the measurement volume and/or portions of the measurement volume (e.g., the base) are static (e.g., not moving relative to an ambient environment), but can alternatively be captured while the measurement volume and/or portions thereof are in motion. The measurements for the items concurrently within the measurement volume are preferably concurrently sampled (e.g., sampled at the same time), but can alternatively be serially sampled (e.g., while the items are being moved into and/or out of the measurement volume) and/or at any other time or with any other suitable relationship.

The measurements preferably include visual data, but can alternatively include force measurements and/or any other suitable set of measurements. The visual data is preferably a set of images, wherein each image within the set is captured by a different camera. Additionally or alternatively, the visual data can be a single image, constant stream (e.g., video), depth information (e.g., a point cloud, a depth map, etc.), structured light image, height maps, 3D images, 2D images, or any other suitable visual data. The image is preferably a color image (RGB image), but can alternatively be a color image with depth information (e.g., associated with each pixel of the color image, such as that generated from a stereocamera pair), be a depth image, and/or be any other suitable image.

Each instance of S200 can include sampling one or more images with each camera (and/or camera pair); when multiple images are sampled by a camera, the multiple images can be averaged, reduced to a single image (e.g., the clearest image is selected from the plurality), or otherwise processed.

The set of images are preferably images of a scene, but can additionally or alternatively be images of any other suitable element. The scene preferably includes one or more items, but can additionally or alternatively include the calibration pattern, a known fiducial, and/or any other suitable elements. Each image preferably captures one or more of the items within the scene, and can optionally capture the calibration pattern, the known fiducial, and/or other scene elements. The set of images preferably captures a plurality of views of the scene (e.g., M views of the scene, M/2 views of the scene, (M−1)/2 views of the scene, etc.), but can additionally or alternatively capture a single view or any other suitable view. The plurality of views preferably include a front view, a left side view, a right side view, a back view, but can additionally or alternatively include any other suitable view. The images are preferably aligned and/or registered with a camera frame and the common coordinate system (e.g., using the calibration matrices determined from S100). The set of images preferably includes 8 or more images, but can additionally or alternatively include 1 image, less than 5 images, less than 10 images, or any other suitable number of images. The set of images preferably includes a color 2D image and a depth image, but can additionally or alternatively include any other suitable images.

However, S200 can additionally or alternatively include any other suitable elements performed in any suitable manner.

### 5.3 Identifying Each of a Set of Items Using the Measurements

Identifying each of a set of items using the measurements S300 functions to determine the identity of the items within the measurement volume (e.g., which items are to be checked out), such that the item can be included in the transaction. The items are preferably statically positioned (e.g., within the measurement volume, relative to the ambient environment, globally static, etc.) during S300, but can alternatively be mobile and/or otherwise positioned during S300. The items are preferably identified based on the appearance of each item depicted within the measurement (e.g., visual appearance within the visual data), but can additionally or alternatively be identified based on the geometric features of each item captured within the visual data, based on weight information of each item (e.g., captured as it is placed into the measurement volume), based on a semantic identifier detected within the measurement, without use of a semantic identifier, and/or based on any other suitable measurement of the set of items.

S300 can be performed: automatically, at a predetermined frequency, responsive to detection of new items within the measurement volume, responsive to motion detection within the measurement volume, responsive to receipt of a user input (e.g., an identify items instruction), responsive to any other suitable event, after completion of a prior transaction, while a checkout confirmation is not received, and/or at any other time. For example, S300 can be performed each time a new set of items (e.g., a new batch of items) is inserted into the measurement volume. In another example, S300 can be performed each time a button (e.g., on a system or POS interface) is selected by the user. However, S300 can be performed at any other time.

S300 is preferably performed at least once for each set of items, but can alternatively be performed multiple times for each set of items. A set of items is preferably a batch of items, but can alternatively include multiple batches of items, a single item, and/or any other suitable set of items. A batch of items preferably includes all items located within a measurement volume at a given time (e.g., items concurrently located within the measurement volume), but can be otherwise defined. A batch of items can include one or more items.

S300 can include: determining a geometric representation of the set of items S310, determining region masks based on the geometric representation S330, generating a surface reconstruction for each item S350, generating measurement segments for each item based on the surface reconstruction S370, determining an identifier for each item using the measurement segments S390, and/or be otherwise performed.

Determining a geometric representation of the set of items S310 functions to determine geometric information about the items within the measurement volume. The geometric representation for the set of items (e.g., batch geometric representation, set geometric representation, etc.) can is preferably a point cloud, but can additionally or alternatively be a mesh, a height map (e.g., a map of the tallest points in each pixel or x/y position), an image (e.g., wherein each pixel can include a height channel), a volumetric representation, and/or be any other suitable geometric representation. The geometric representation can be registered relative to a virtual reference point, or be unregistered. The registration can be based on the calibration matrices determined in S100 and/or any other suitable calibration information. The geometric representation is preferably representative of the items within the measurement volume, but can additionally or alternatively be representative of the entirety of the measurement volume (e.g., including surfaces, such as the base) or any other suitable portion of the measurement volume. The geometric representation can include the set of items within the measurement volume, include the base of the housing, include other portions of the housing, include only the set of items (e.g., wherein the housing base is removed from the geometric representation), and/or represent any other suitable component within or adjacent to the measurement volume. The geometric representation preferably depicts the entire measurement volume (e.g., represents all items within the measurement volume), but can additionally or alternatively represent a single item within the measurement volume, a subset of the items, and/or any suitable portion of the items.

S310 is preferably performed after S200, but can additionally or alternatively be performed during or before. S310 is preferably performed after determination of the calibration matrices, but can additionally or alternatively be performed contemporaneously. The geometric representation is preferably determined using the visual data determined in S200, but can additionally or alternatively be generated using known geometries, probe routines, time of flight measurements, or other data. The visual data is preferably transformed into the point cloud based on the calibration matrices but can additionally or alternatively be transformed based on any other suitable transformation. After geometric representation generation, the geometric representation can be quantized (e.g., 1 mm cubed, 2 mm cubed, 1 cm cubed, etc.) and/or otherwise manipulated.

In variants, the geometric representation can be determined using methods described in U.S. application Ser. No. 15/685,455 filed 24 Aug. 2017, U.S. application Ser. No. 17/246,409 filed 30 Apr. 2021, and/or U.S. application Ser. No. 17/323,943 filed 18 May 2021, each incorporated herein in its entirety by this reference.

In a second variation, S310 determines the geometric representation by determining a depth of an item feature from the sensor, (e.g., depth per pixel in a camera coordinate system), and mapping the feature depth to the common coordinate system using the calibration matrices determined in S100. In a first embodiment, determining the feature depth can include triangulating a depth of a common feature found between two images of a stereoimage pair. In a second embodiment, the feature depth can be measured by a depth sensor (e.g., structured light sensor). However, the feature depth (e.g., feature distance away from the sensor) can be otherwise determined.

In a third variation, S310 can determine the geometric representation based on projective reconstruction and factorization, affine reconstruction and factorization, bundle adjustment, or using any other suitable technique.

In a fourth variation, S310 includes combining points from a plurality of sensors (e.g., structured light sensors, stereocameras, etc.) and optionally meshing the points to form the geometric representation.

In a first example, the visual data can be a plurality of 2D stereo color images and depth images. Points can be individually determined from each stereocamera image and depth image, and collectively merged, using the respective common coordinate transformation matrices (e.g., calibration matrices), into a point cloud within a common (virtual) space.

In a fifth variation, the geometric representation is a height map determined from a point cloud (e.g., quantized, not quantized, etc.). The height map is preferably a top-down height map of the measurement volume, but can alternatively be an elevation view and/or other view. The height map can include: a set of points (e.g., the points with the largest z value for each (x,y) combination in the point cloud), a hull (e.g., interpolated over the highest points in the point cloud, interpolated over the entire point cloud, etc.), or be otherwise represented. For example, the height map can be determined based on the top view of the point cloud, wherein the base defines the x, y plane and the z axis extends from the origin of the x, y plane and is perpendicular to the base. The height map can include (x, y, z) coordinates associated with the maximum z value for the (x, y) position. Alternatively, the height map can be determined based on a side view of the point cloud. The axis (e.g., x or y axis) that extends perpendicular to the z-axis and parallel with the base can be used to determine the points closest to the side view that can be maximized or minimized accordingly. For example, if the height map is determined from the left side view, the height map will include points associated with the (x, y, z) coordinates associated with the minimum x value.

In a sixth variation, the geometric representation is a binary mask. The binary mask can be the top view of the point cloud, but can be otherwise determined. In a first example, determining the binary mask includes identifying all x-y coordinates with point cloud points having a height (e.g., z-value) above a predetermined threshold (e.g., 0), and setting the remainder of the x-y coordinates to zero. In a second example, determining binary mask includes (x, y, z) coordinates associated with the maximum z value for the (x, y) position and once the subset of points is determined, setting the z values to zero. However, the binary mask can be otherwise determined.

In a seventh variation, the geometric representation is a mesh (e.g., a coarse mesh), and can represent a full- or near-full volumetric representation of the items within the measurement volume. In this embodiment, the geometric representation can include a mesh, can be a blob representing adjoining items (e.g., items touching each other), or include a different mesh for each individual item.

In an eighth variation, the geometric representation is a chordiogram, wherein the chordiogram is determined based on the top view of the point cloud.

However, S310 can additionally or alternatively include any other suitable elements performed in any suitable manner.

Determining region masks based on the geometric representation S330 preferably functions to determine volumetric or geometric segments for each item in the measurement volume. Region masks for individual items are preferably determined concurrently (e.g., as a batch), but can additionally or alternatively be individually determined (e.g., serially), or in any other suitable order.

The region masks are preferably defined in a common virtual space (e.g., the geometric representation, the point cloud, etc.), but can additionally or alternatively be defined: in each image, in a camera frame, and/or in any other suitable virtual space. The region masks can include: a bounding box (e.g., in the x-y plane); boundaries in the x-y plane; one or more areas in the x-y plane; one or more 3D regions in the x, y, z volume, and/or be otherwise defined. The region mask is preferably a binary mask (e.g., each pixel value is 1 if the pixel corresponds to an item and 0 otherwise, but can alternatively be any other suitable mask. The region mask is preferably 2D, but can alternatively be 3D, 2.5D (e.g., have contours for only a subset of the geometric representation or measurement volume), and/or have any other suitable dimensions. The region mask is preferably subsequently applied to the geometric representation (e.g., to determine the 3D blobs and/or height maps for each individual item), but can additionally or alternatively otherwise used. The region masks are preferably a height map masks, but can additionally or alternatively be a mask for the geometric representation, and/or mask for any other suitable data. Each region mask can be representative of a separate and distinct item (e.g., associated with a single PLU, associated with unitary packaging, etc.), but can additionally or alternatively be representative of multiple items. In a first example, a single region mask can encompass a 6-pack of cans. In a second example, each can is associated with a different region mask, wherein a 6-pack is split into 6 region masks. Each region mask can be associated with a mask identifier (e.g., generic, alphanumeric, etc.) representative of a separate and distinct item. S330 can generate one or more masks. For example, S330 can generate: a mask per item; multiple masks per item; a single mask for multiple items; and/or any suitable number of masks for any suitable number of items in the measurement volume.

The region masks can be generated by: segmenting the geometric representation of the item set (e.g., segmenting a height map, segmenting a point cloud, etc.), segmenting the images of the visual data, segmenting any other data, and/or otherwise determined.

The region masks are preferably determined using a segmentation classifier, but can additionally or alternatively be determined using edge based methods (e.g., gradient based algorithms, scan line grouping algorithms, binary contour extraction, etc.), using graph-based methods (e.g., KNN, Markov Random Field, etc.), using foreground/background segmentation, a set of rules (e.g., determining a line that divides adjoining items based on a planar or elevation view, and extending the line through the orthogonal plane or along the vertical plane to segment the volume; filtering for items or pixels with a height matching each of a predetermined set of heights, where contiguous pixels having the same height can be considered a segment; etc.), and/or any other suitable technique.

The segmentation classifier can leverage: semantic segmentation, instance-based segmentation, rules, heuristics, and/or any other suitable segmentation technique. The segmentation classifier can be a region-based algorithm (e.g., MaskRCNN, RCNN, FastRCNN, FasterRCNN, etc.; seeded-region methods, unseeded-region methods, etc.) and/or any other suitable algorithm. The segmentation algorithm can output: individual region masks (e.g., for each item), a boundary that is subsequently used to determine a region mask (e.g., a linear boundary, an item boundary, etc.), and/or any other suitable data. The segmentation classifier is preferably trained, but can additionally or alternatively be a non-parametric model, a pre-trained model, or otherwise specified. The segmentation classifier is preferably trained using training data (e.g., synthetic data, real data, etc.), but can additionally or alternatively include any other suitable data.

In a first variation, the segmentation classifier can be trained using synthetic images (e.g., synthetic images can be generated using a generative adversarial network; generated using heuristics, random sampling, etc.). The generative adversarial network can generate new orientations of items similar to the orientations represented in the training data. Generating the synthetic images can include geometrically combining geometric representations (e.g., height maps) for multiple items (e.g., randomly selected items), adding noise, or otherwise generating synthetic images and/or generating synthetic point clouds. Geometric combinations can include: rotation, translation, collision, placing the items in different x, y, and/or z positions (e.g., different positions for item centroids can be randomly selected, deterministically sampled, etc.), or any other suitable combination.

In a second variation, the segmentation classifier can be trained using real data. The real data can be collected by the imaging system. Each item can be added to the scene sequentially. After each item placement, the sampling system can take a difference in the scene (e.g., the difference between the previous scene and the observed scene) to obtain a mask for the item.

However, the segmentation classifier can be otherwise determined.

Determining the region mask for each item based on the geometric representation functions to segment the volumetric space. The region mask can include: a mask (e.g., binary image representing the geometric representation segment for an item in 2D or 3D space), an item boundary (e.g., boundary of the geometric representation segment), bounding box, or other segment representation.

In a first variant, region masks for each item in the geometric representation are determined by the segmentation classifier described above, wherein the geometric representation is provided to the segmentation classifier and a set of region masks are returned.

In a second variant, determining the region mask for each item in the geometric representation includes iteratively identifying an item using the geometric representation (e.g., by matching volumes of known items to the contours of the geometric representation) and subtracting the identified item from the geometric representation.

In a third variant, determining the region mask for each item in the geometric representation includes: determining item boundaries from the geometric representation, and generating a mask for each closed-loop item boundary. In this variation, determining item boundaries from the geometric representation can include: identifying the pixels, voxels, or points within the geometric representation where the height falls below a threshold value or is equal to the base height; determining the transition to one or more minima of the height map; determining continuous regions of the geometric representation (e.g., blob) with a height above a predetermined threshold and taking the boundary of the continuous region; using edge based methods (e.g., gradient based algorithms, binary contour extraction, scan line grouping algorithms, etc.), or otherwise determining the item boundaries.

In a fourth variant, determining the region mask for each item in the geometric representation includes: taking the projection of the geometric representation onto an x-y plane (e.g., lowest x-y plane of the height map; bottom plane of the measurement volume; etc.). This can optionally include segmenting the projection into item projection segments, wherein the item projection segments can be segmented using: a segmentation classifier, a set of heuristics (e.g., based on geometric features of the projection, based on whether the items are in contact, etc.), and/or otherwise determined. In an example, noncontiguous blobs can be considered individual item projection segments. In a second example, blobs with necks (e.g., narrowed or reduced region along the blob body) can be segmented (e.g., along the neck; perpendicular the neck, etc.). However, the projection can be otherwise segmented.

In a fifth variant of S330, segmenting the geometric representation includes: determining a mask for each item using background subtraction, wherein noncontiguous masks or regions are associated with an item. The remaining (e.g., contiguous) pixels, points, or geometric representations can make up the mask for each item.

In examples, segmenting the geometric representation can be performed using techniques described in U.S. application Ser. No. 15/685,455 filed 24 Aug. 2017, U.S. application Ser. No. 17/246,409 filed 30 Apr. 2021, and/or U.S. application Ser. No. 17/323,943 filed 18 May 2021, each incorporated herein in its entirety by this reference.

In variants, transparent items can be determined based on the geometric representation, the point cloud, and/or otherwise determined. In this variation, a transparent item can be identified as a region within the geometric representation associated with impossible values or no data (e.g., negative infinity, infinity, etc.). Additionally or alternatively, a transparent item can be detected from the color images. In one example, a transparent item can be detected as a region that excludes the standard calibration pattern (e.g. (x, y, 0), or any other suitable coordinate for the background), but is not associated with depth information and/or color values.

In variants, S330 can optionally include determining whether items are in contact (e.g., within an item boundary). Determining whether items are in contact can be performed: before the masks are determined (e.g., wherein the height map, point cloud, or image is segmented using a segmentation module before mask determination if the items are in contact); after the masks are determined (e.g., wherein a mask with multiple items can be subsequently segmented); not performed (e.g., wherein a segmentation module or classifier is used for all iterations of the method), or performed at any other suitable time.

Determining whether items are in contact can function to determine whether further processing (e.g., additional segmentation steps) need to be performed. Determining whether items are in contact is preferably performed based on the height map, but can additionally or alternatively be based on the point cloud, the set of images, or any other suitable data. Determining whether items are in contact can be performed using background subtraction techniques, analyzing shadows, minima analysis, or using any other suitable technique. In examples, items are considered to be in contact when: the blob boundary (e.g., item blob boundary) includes a neck (e.g., an intermediate region with a smaller width than the surrounding regions); the blob's region of the height map includes an intermediate minima lower than a predetermined threshold; the blob's height map has a sharp height change or discrepancy; the images (e.g., the top-down image) indicates a sharp visual discrepancy; the number of items inserted into the measurement volume (e.g., based on initial item tracking, number of weight increases, etc.) is more than the number of detected individual items in the height map; and/or otherwise determined to be in contact.

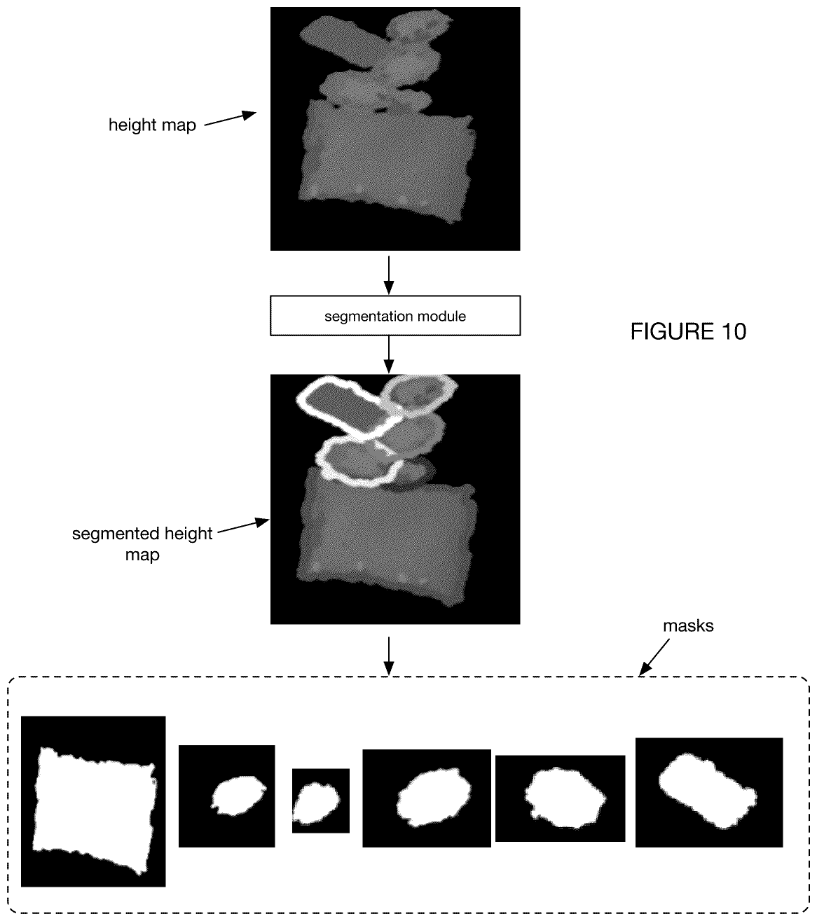

In a first specific example, the geometric representation of the items can be segmented using a MaskRCNN algorithm. The geometric representation can be a height map generated from a point cloud. The output data is a mask for each item represented by the height map, with binary pixels wherein a 1 represents item pixels and 0 otherwise, or the mask can be otherwise represented. An example is shown in FIG. 10.

In a second specific example, the geometric representation of the items can be segmented by identifying an inter-item boundary (e.g., based on the height map, based on images associated with the height map region, based on heuristics, etc.) and providing a line (e.g., in the x-y plane) extending through the geometric representation along a portion of the inter-item boundary, wherein the geometric representation of the items can be segmented using the line (e.g., along the line).

However, the region masks can be otherwise determined.

Generating a surface reconstruction for each item S350 can function to determine a more volumetrically complete representation of each unknown, detected item based on the region masks. The surface reconstruction can subsequently be used to register the 3D points in the common coordinate system with the corresponding 2D points in each original camera coordinate system, but can additionally or alternatively be otherwise used. S350 is preferably performed after S330 but can be performed contemporaneously as region masks are determined and/or at any other suitable time.

S350 preferably outputs a set of surface reconstructions, wherein each surface reconstruction within the set corresponds to a different item, but can additionally or alternatively output a surface reconstruction for the entire scene, or output any other suitable surface reconstruction. The set of surface reconstructions are preferably determined within the common coordinate system, but can additionally or alternatively be determined outside of the common coordinate system.

The surface reconstruction generated by the surface reconstruction algorithm is preferably a mesh, but can additionally or alternatively be any other suitable data. The mesh is preferably a coarse mesh, but can additionally or alternatively be a medium mesh, a fine mesh, or any other suitable mesh. The mesh can be structured, unstructured, block structured, or be otherwise structured. The mesh is preferably constructed from a geometric shape (e.g., triangle, diamond, rectangle, etc.), but can additionally or alternatively be a combination of geometric shapes, or otherwise constructed. The mesh is preferably a convex hull, but can additionally or alternatively be of an affine hull, conic hull, or be otherwise defined.

Each surface reconstruction (and/or subelement thereof) is preferably associated with a position in the common coordinate system. The position is preferably determined based on the geometric shape vertices and/or 3D points used to generate said vertices. For example, the mesh can be constructed from triangles that represent the surface of an item. Each vertex of each triangle can be represented as a 3D point in the common coordinate system. However, the surface reconstruction can be otherwise related to the common coordinate system.

The surface reconstruction is preferably generated based on the geometric representation and the region masks, but can additionally or alternatively be generated based on the point cloud and region masks, or based on any other suitable data. For example, the surface reconstruction can be generated based on: the geometric representation, wherein the geometric representation is the height map; a segmented height map (e.g., the entire height map with aligned masks); a height map segment corresponding to a masked region of the height map (e.g., associated with a common coordinate space pose, position, and/or orientation); the point cloud; a segmented point cloud, wherein the point cloud is segmented based on the height map segmentation or masks; a point cloud segment (e.g., determined based on the masks; or any other suitable data.

The input data transformation is preferably a surface reconstruction algorithm (e.g., convex hull algorithm, affine hull algorithm, finite distance, finite element, finite volume, triangulation, poisson, etc.). The surface reconstruction algorithm is preferably based on a view of the point cloud (e.g., the top view, a side view, etc.). The view is preferably a partial view, but can additionally or alternatively be any other suitable view. The partial view is preferably determined based on the region masks determined in S330, but can be determined based on any other suitable data.

The surface reconstruction algorithm can include a plurality of instances or a single instance. When the surface reconstruction algorithm includes a plurality of instances, each instance of the plurality computes a surface reconstruction based on a subset of points of the original point cloud wherein each subset of points corresponds to an item, but the surface reconstruction can be otherwise based. Each subset of points are preferably the points remaining after applying the item masks to different instances of the point cloud. However, the masks can be applied to the same instance of the point cloud, or any other suitable data. Each subset of points are transformed in parallel, but can be transformed sequentially, or in any other suitable order. The surface reconstruction algorithm can process each subset of points using different instances of the algorithm, the same instance of the algorithm, or otherwise process each subset of points.

When the surface reconstruction algorithm includes one instance, the instance computes a surface reconstruction based on the geometric representation of the set of items (e.g., the point cloud). The surface reconstruction is then segmented into item segments based on the item masks.

In a first variation, S350 includes: masking the geometric representation with the region masks determined in S330 (e.g., identifying all points within the geometric representation encompassed by a projection of the region mask downward and/or upward along the z-axis), and generating a convex hull based on the points within each masked region of the point cloud.

In a second variation, S350 includes: segmenting the geometric representation (e.g., height map) using the region masks from S330 and projecting the geometric representation segment (and/or boundaries thereof) downward along a z-axis of the measurement volume or common coordinate system. In a first embodiment, the geometric representation is a hull, wherein projecting the geometric representation segment downward can include creating vertical side surfaces for the hull (e.g., extending downward to the base from the perimeter of the hull or mask). In a second embodiment, the geometric representation is a set of points, wherein a hull is generated based on the points and vertical side surfaces for the hull (e.g., by extending the perimeter of the hull or mask downward). However, the geometric representation can be otherwise used to generate the hull.

In a third variation, S350 includes: generating a convex hull for the height map, and masking the convex hull to identify the convex hull sub-portions that correspond to individual items.

In a fourth variation, when the geometric representation for the set of items (e.g., the point cloud) is segmented directly, the convex hull can be generated based on the region masks (e.g., point cloud segments).

In a fifth variation, S350 includes: projecting each region mask along the z-axis to generate the sidewalls of the surface reconstruction, and joining the height map with the sidewalls to cooperatively form the convex hull.

However, the surface reconstruction can be otherwise determined.

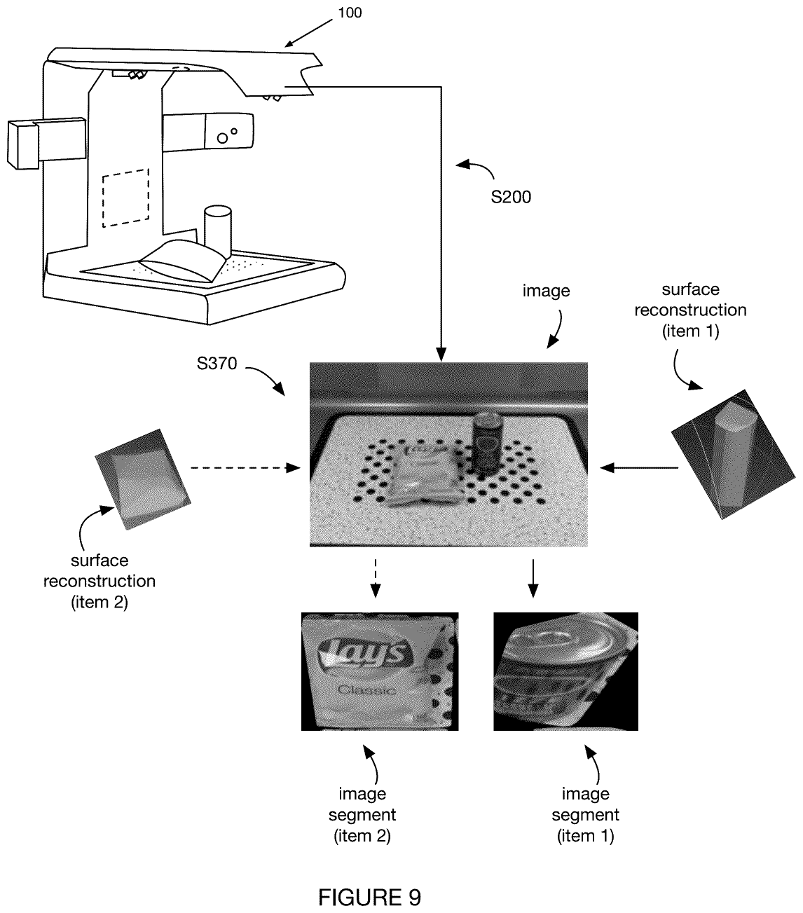

Generating measurement segments for each item based on the surface reconstruction S370 functions to determine the measurement segments (e.g., image segments, visual segments, etc.) corresponding to a single unknown individual item (e.g., shown in FIG. 9) from each of a set of images. S370 is preferably performed after S350, but can additionally or alternatively be performed contemporaneously.

S370 preferably outputs a set of measurement segments (e.g., image segments, geometric segments, etc.) per item. The cardinality of the set preferably equals the number of input images (e.g., base images), but can have any other suitable number. For example, for M input images, S370 preferably outputs M image segments per item (e.g., when the scene includes N items, S370 outputs N×M image segments). In a specific example, the set of image segments includes an image segment from each image from the image set used to generate the point cloud. In a second specific example, the set of image segments can include an image segment from a subset of the images from the image set (e.g., only the color images). However, any other suitable number of image segments can be output.

Each set of measurement segments preferably includes only the portions of the respective item appearing in the base measurement (e.g., base image), wherein obscured portions of the respective item and/or substantial portions of other items (e.g., more than a threshold percentage, such as 1%, 5%, 10%, etc.) do not appear in the measurement segment. However, the set of measurement segments can include portions of other items, portions of the background, the sampling system, the standard calibration pattern, or any other suitable elements. The edges of the measurement segment can be defined by the edges of the item (e.g., instance segmentation), defined by a bounding box, or otherwise defined. The pixels of each image are preferably from the color image associated with the respective 3D camera, but can be from any other suitable data.

Different sets of measurement segments for different items can be determined: concurrently (e.g., in a batch), serially (e.g., for each item, for each image, etc.), or in any other suitable order.

The measurement segments are preferably determined from the set of color images (e.g., determined in S200), but can alternatively be determined from the depth images or any other suitable data. Each image can be associated with a respective calibration matrix transforming the common coordinate system to the respective camera coordinate system, and/or transforming the camera coordinate system to the common coordinate system, such as those determined in S100. The color images are preferably 2D images from each constituent camera of the 3D sensors (e.g., the monocular cameras cooperatively forming the stereocameras), but can be any other suitable color images (associated with a transformation from the common coordinate space). The color images preferably include a 2D image from each camera, but can additionally or alternatively include 2D images from a subset of the cameras.

The measurement segments are preferably determined using the surface reconstruction (e.g., determined in S350), but can additionally or alternatively be determined using the region masks determined in S330, or otherwise determined. S370 can include, for each (unknown) item, projecting the respective surface representation into each camera frame (e.g., associated with each image sampled in S200), wherein the measurement segment corresponding to the item is determined from the projection. However, the measurement segment corresponding to an image can be determined using ray tracing, rasterization, scan line rendering, image order algorithms (e.g., ray casting), object order algorithms (e.g., scan conversion, shear warp, etc.), or otherwise determined.

Projecting a surface representation into a camera frame can include identifying the region of the image frame (e.g., the image's pixels) that map to the shadow of the surface representation on the camera frame (image frame, image space). The projection can be performed in the common coordinate system, in the camera frame, or in any other suitable coordinate system. In a one example, S370 includes transforming the surface representation (e.g., for the item, for the scene, etc.), which is represented in the common coordinate system, to the camera frame or coordinate system (e.g., using the respective calibration matrices determined in S100); and selecting the pixels in the respective image that correspond to the surface representation for the item, wherein the selected pixels (or pixel regions) cooperatively form the image segment. In a second example, S370 includes transforming each measurement's frame to the common coordinate system (e.g., using the calibration matrices determined in S100), projecting the surface representation onto the measurement, and selecting the pixels, voxels, or other measurement unit within the projection as the item's measurement segment. In a first variation, the selected pixels correspond to the unobstructed points or regions of the item's surface representation that are closest to the image's camera frame. In an example, the triangle locations of an item's convex hull are mapped to color image pixel locations to determine the pixels corresponding to the item. In a second example, only portions of the surface representation that are the closest to the image frame (e.g., relative to surface representations for other images in the common coordinate space) are projected. In a third example, S370 includes projecting all surface representations for all items into a given image, identifying image regions (e.g., mesh units, pixels, etc.) that are assigned to (e.g., within the projection of) multiple conflicting surface representations, sorting the conflicting surface representations by proximity to the image frame, and assigning the image region to the item whose surface representation is closest to the image frame. In a fourth example, all surface representations for all images within the measurement volume are concurrently projected into the image frame, and the image's pixels can be assigned to the item whose surface reconstruction projection was unobstructed. In a fifth example, the image is projected into the common coordinate frame (e.g., with the surface representations of the one or more items in the measurement volume), wherein each image pixel is assigned to the first surface reconstruction that the image frame projection intersects. In a sixth example, if multiple triangles of an item's convex hull map to the same image region, a secondary mask is determined. The secondary mask is determined by the triangle closest to the imaging system element (e.g., 3D camera). When the secondary mask is associated with the item (for which the measurement segment set is being generated), measurement units, such as pixels (or one or more measurement segments within each measurement) corresponding to the secondary mask can be selected. In a second variation, the selected pixels correspond to the region mask determined in S330.

In a third variation, the entire measurement segment associated with a surface reconstruction projection can be assigned to the item, irrespective of surface reconstruction obstruction by another item's surface reconstruction.

However, the measurement segments can be otherwise determined.

Determining an identifier (e.g., item identifier) for each item S390 functions to identify the item. S390 is preferably performed after S370, but can additionally or alternatively be performed during or before (e.g., on an image from each camera). S390 is preferably performed by the sampling system, but can additionally or alternatively be performed at the remote computing system or at any other suitable computing system.

The identifier is preferably determined based on the measurement segments for each item from S370. For example, the identifier can be determined based on the image segments for each item. The identifier can optionally be determined based on the geometric representation for the item from S330 or a geometric representation segment corresponding to the item from S350. However, the identifier can additionally or alternatively be determined based on the original images, the point cloud, features of the input data (e.g., extracting using histogram of oriented gradients (HOG), Scale invariant Feature Transform (SIFT), speeded up robust feature (SURF), etc.), or any other suitable data.

In a first variant, item identifiers are preferably determined for each piece of item data (e.g., image segment and/or geometric item representation). In this variant, the individual identifiers can be deconflicted to determine a final item identifier using a voting algorithm, a selection mechanism (e.g., wherein different pieces of item data can be given different weights; wherein different identifier predictions can have different confidence scores, etc.), and/or otherwise determined.

In a second variant, an item identifier is determined using a set of item data (e.g., a set of image segments and/or geometric item representations). For example, a feature vector can be extracted from each item datum (e.g., image segment) for an item, wherein the item identifier is determined based on the resultant set of feature vectors. However, any other suitable number of item identifiers can be determined for any other suitable set of item data (e.g., image segments, geometric item representations, etc.).

The item identifiers are preferably determined by a standard classifier (e.g., neural network: DNN, CNN, feed forward neural network; regression; nearest neighbors; SVM; etc.), but can alternatively be determined using a set of rules, heuristics, or other item detector.

The item detector functions to determine an item identifier based on item data, but can additionally or alternatively determine a probability vector corresponding to a subset of the class-IDs (e.g., top 3 class-IDs, top 5 class-IDs), or determine any other suitable output. The item data can include: image segments, point cloud regions, geometric representation segments, and/or any other suitable data. The sampling system can include one or more classifiers for each: data type, camera view, item, and/or other parameters. For example, the sampling system can include: a single classifier that is used for all camera views or different classifiers for each camera view or camera. In another example, sampling system can include: a single classifier for all data types (e.g., the same classifier is used for images and height maps) or the different classifiers for different types of data (e.g., one classifier for images, a second classifier for height maps). In another example, the sampling system can include: a single classifier for all items, different classifiers for each item, different classifiers for each super-class (e.g., wherein item identification can leverage a series of classifiers), and/or any other suitable number of classifiers for any other suitable number of items.

Each classifier of the system preferably accepts a single input, but can additionally or alternatively accept multiple inputs. For example, the classifier can accept a single image segment or a single height map segment; or accept multiple image segments and/or height map segments. However, the item classifier can be otherwise constructed.

In a first variation, S390 includes, for each (unknown) item: determining a set of class candidates; and determining the item identifier from the set of class candidates. Determining the set of class candidates can include: determining a candidate class for each of the set of measurement segments associated with the respective item using a classifier, and optionally determining a candidate class for the respective geometric representation segment using a geometric classifier, wherein the resultant candidate classes cooperatively form the set of class candidates. The classifiers used to classify each measurement segment is preferably the same classifier, but can alternatively be different classifiers.

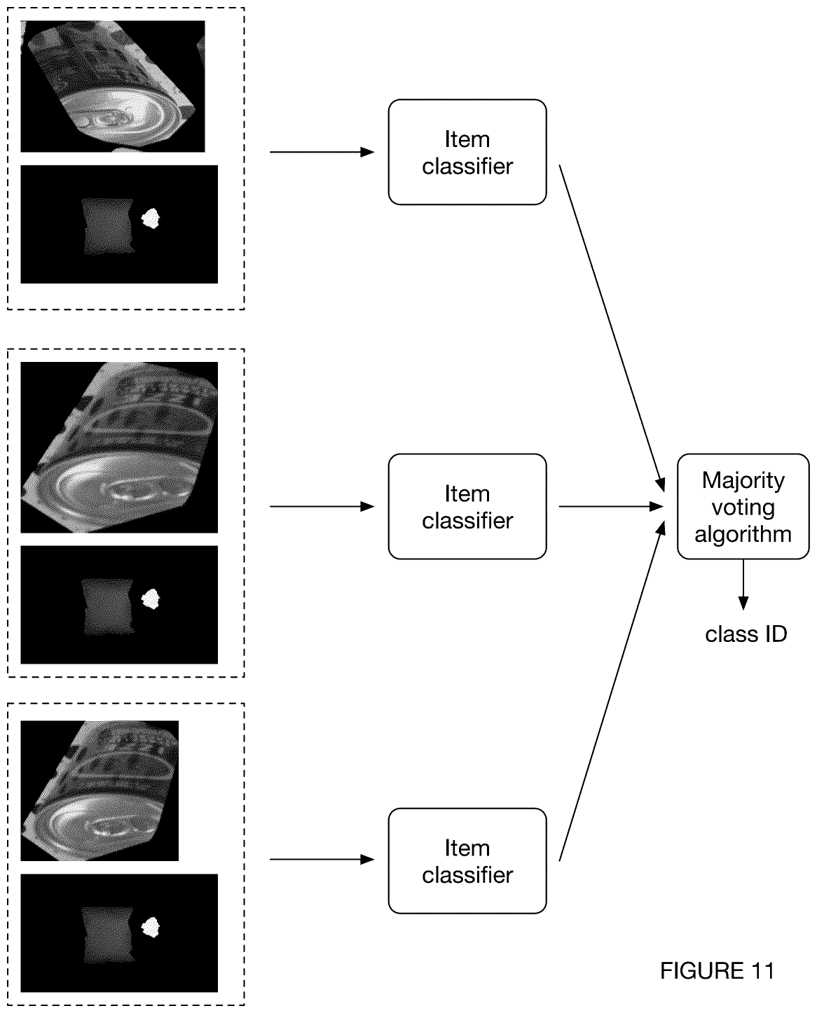

Determining the item identifier from the set of class candidates can include: voting on the item identifier (e.g., using a majority voting algorithm, wherein the most common class candidate within the set is selected as the item identifier, example shown in FIG. 11); selecting a highest-confidence class candidate as the item identifier; selecting the class candidate based on the respective probabilities (e.g., by adding the probability scores for each class-ID across all outputs in the set and choose the class-ID corresponding with the maximum value); or otherwise determining the item identifier.

In a second variation, S390 includes, for each (unknown) item: feeding the respective measurement segments (and optionally, geometric representation segment) into a classifier, wherein the classifier outputs the item identifier.

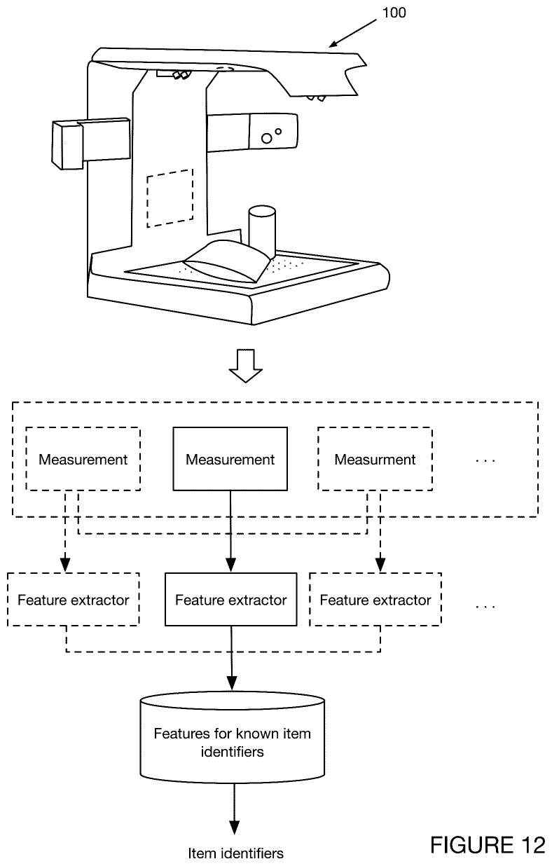

In a third variation, S390 includes, for each (unknown) item: determining a feature vector for each measurement segment (e.g., using different instances of the same classifier); optionally determining a geometric feature vector for the respective geometric representation segment; and determining the item identifier based on the image feature vectors and, optionally, the geometric feature vector. The feature vector can be determined using: a trained decoder, a subset of the layers of a neural network trained to predict an item class based on the measurement, and/or using any other model, feature encoder, and/or set of layers. Determining the item identifier can include: concatenating the image feature vectors and, optionally, the geometric feature vector to form a single input vector, and feeding the concatenated input vector a secondary classifier, wherein the secondary classifier outputs the item identifier. Additionally or alternatively, determining the item identifier can include determining a distance or similarity score (e.g., similarity metric) between the unknown item's feature vectors (e.g., image and/or geometric feature vectors) and a set of reference feature vectors (e.g., image and/or geometric feature vectors) associated with a set of known item identifiers, and selecting the item identifier associated with the best distance or similarity score (e.g., smallest distance, furthest distance, most similar, etc.); an example is shown in FIG. 12. Examples of distance and/or similarity models that can be used include: cosine distance, Euclidean distance, Bregman divergences (e.g., Mahalanobis distance, etc.), Bhattacharyya distance, a trained similarity model, and/or any other suitable distance and/or similarity model or algorithm. However, the item identifier can be otherwise determined based on the image feature vectors and/or the geometric feature vector.

In a fourth variation, determining a class identifier is performed using techniques described in U.S. application Ser. No. 17/079,056 filed 23 Oct. 2020, U.S. application Ser. No. 17/246,409 filed 30 Apr. 2021, and/or U.S. application Ser. No. 17/323,943 filed 18 May 2021, each of which is incorporated in its entirety by this reference.

However, the identifier can be otherwise determined.

However, each item within the set can be otherwise identified.

The billing information for each identified item is preferably aggregated into a bill or invoice for payment. The billing information for the item can include: the price per item, the number of units for each item (e.g., a 6-pack of cans can include 6 cans), the accepted forms of payment for the item, and/or any other suitable billing information. In an illustrative example, when an apple, “dish 1”, and “dessert 2” are detected within the measurement volume, line items for the apple, “dish 1”, and “dessert 2” can be added to the invoice. A new invoice can be generated for each checkout session, after payment information is received and/or the payment is processed for a prior session, and/or for any other suitable set of items. Checkout sessions can be defined as each new item batch detection, be defined between sequential stop condition detections, span a single identification session, span multiple identification sessions, be a duration during which an addition condition is satisfied, and/or be otherwise defined.

Each invoice can include billing information for a single batch of items, or include billing information for multiple batches of items (e.g., multiple sets of items). In the latter variant, the multiple item batches billed on the same invoice are preferably processed (e.g., identified) by the same system 20 (e.g., sequentially), but can alternatively be processed by different systems 20. The multiple item batches are preferably sequentially processed, but can alternatively be concurrently processed.

Subsequent item batches are preferably processed using S200-S300 as discussed above (e.g., by repeating and/or iteratively repeating S200 and S300 for successive batches until a stop condition is met), but can be otherwise processed. In variants, the method can optionally include verifying that a prior batch of items has been removed from the measurement volume before performing S200 for the next batch (e.g., performing another iteration of the method). Verifying that the items have been removed can include: detecting a weight change (e.g., weight drop) using a weight sensor in the base, detecting only the base, determining that more than a proportion of pixels have a height (e.g., depth) greater than a threshold, determining that a position of the items within the measurement volume has changed (e.g., based the items detected from each measurement stream, based on the determined item pose, based on a feature vector comparison, etc.), determining that the items in the measurement volume have changed (e.g., based on a feature vector comparison, wherein the similarity score can be over a threshold distance), detecting a hand within the measurement volume, a combination of the above, and/or otherwise verifying that the items have been removed and/or that the item batch in the measurement volume include a different or new batch of items. However, successive item batches can be otherwise identified.

Billing information for items can be added to the same invoice until a stop condition is satisfied, or until another event occurs. The stop condition can include: receipt of payment information (e.g., detecting payment card insertion or swiping, receiving payment card information, etc.), selection of a “checkout” button (e.g., on a system or POS interface), more than a threshold duration since an item was detected within the measurement volume, removal of all items from the measurement volume, nonsatisfaction of an addition condition, and/or any other suitable stop condition. In variants, item addition to the invoice can be ceased or prevented after stop condition detection. Additionally or alternatively, billing information for items can be added to the same invoice if or while an addition condition (e.g., batch addition condition) is satisfied, wherein payment is received and/or processed when the addition condition is not satisfied. Examples of addition conditions include: selection of a button indicating that more items are to be added (e.g., an “add more items” button or a “continue” button on a system or POS interface), nonsatisfaction of a stop condition, detection that the same user has remained in front of the system 20 or POS system (e.g., based on continuous presence detection, based on facial recognition, based on continuous detection of a unique NFC or Bluetooth beacon associated with a user, etc.), detection of an item lying partially within and/or partially outside of the measurement volume (e.g., a tray that is partially within the measurement volume), and/or any other suitable addition condition. In an illustrative example, payment information can be received after a first batch of items is detected, the user can indicate that more item batches should be added to the bill (e.g., by selecting an “add more items” button, by selecting “continue”, by adding a successive item batch without confirming payment, etc.), and the payment information can be stored until a checkout condition is met (e.g., the user confirms payment).

Receiving payment information S400 functions to obtain information that can be used to bill the user (e.g., payor). The payment information can be received by the POS system, by the system 20, and/or by any other suitable system. The payment information can be received: before item insertion into the measurement volume, before an item is detected within the measurement volume, while an item is detected within the volume, after item detection within the measurement volume, after item removal from the measurement volume, after a checkout indication is received, after a payment prompt is displayed, after an initial item batch is identified, after a final item batch is identified, before the checkout condition is met, after the checkout condition is met, and/or at any other time. S400 can include prompting the user to pay, placing the POS system or the system 20 into a payment state (e.g., configured to interpret information received at a sensor as a certain form of payment), authenticating the payment information (e.g., checking the payment information against a database, verifying a cryptographic signature on the payment information, etc.), storing the payment information until a checkout condition or stop condition is met, and/or otherwise receiving payment. In a first example, the user can be prompted to pay when items are detected or identified within the measurement volume. In a second example, the user can be prompted to pay after the user selects a button indicating that there are no new items to add (e.g., no additional item batches to add to the invoice). However, the user can be prompted to pay and/or the payment can be received at any other time.

Completing the transaction based on the payment information S500 functions to charge for the items on the invoice (e.g., invoice for the items, billing for the items, complete payment for the items, etc.). S500 is preferably performed using the payment information, but can be completed using any other suitable information. S500 is preferably performed after a checkout condition is satisfied, but can alternatively be performed at any other time. The checkout condition can be: a stop condition, selection of a “checkout” button by a user, receipt of payment information, a threshold duration since items were detected within the measurement volume, and/or any other suitable condition. Examples of S500 can include: prompting a cashier to receive cash from the user, generating and sending a credit or debit card transaction for the total invoice amount to payment processor, generating and broadcasting a cryptocurrency transaction for the total invoice amount to a blockchain, and/or otherwise completing the transaction.

### ILLUSTRATIVE EXAMPLES

In a first example, the method includes: detecting a set of items within the measurement volume, identifying each item within the set, generating an invoice for the identified items, prompting the user to pay for the invoice (e.g., while the items are within the measurement volume), receiving payment information from the user, and completing the transaction using the payment information. In this example, different checkout sessions are created for different item batches (e.g., each batch of items is individually checked out). In an illustrative example, a parent can individually pay for each of their family members' trays of food (e.g., one checkout session per tray).

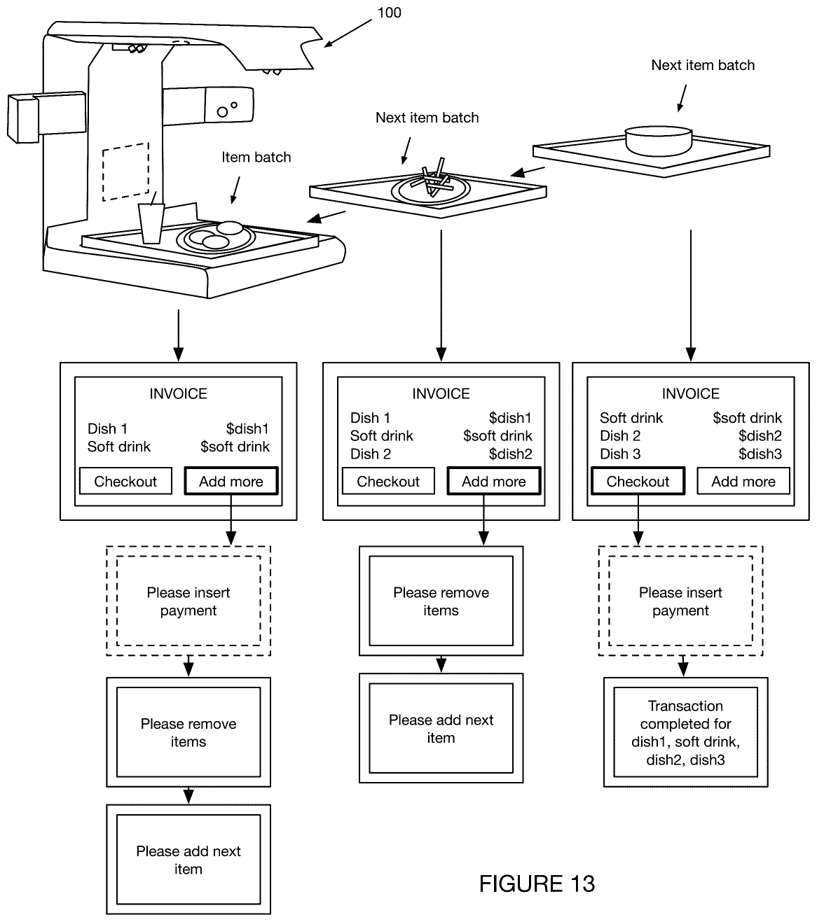

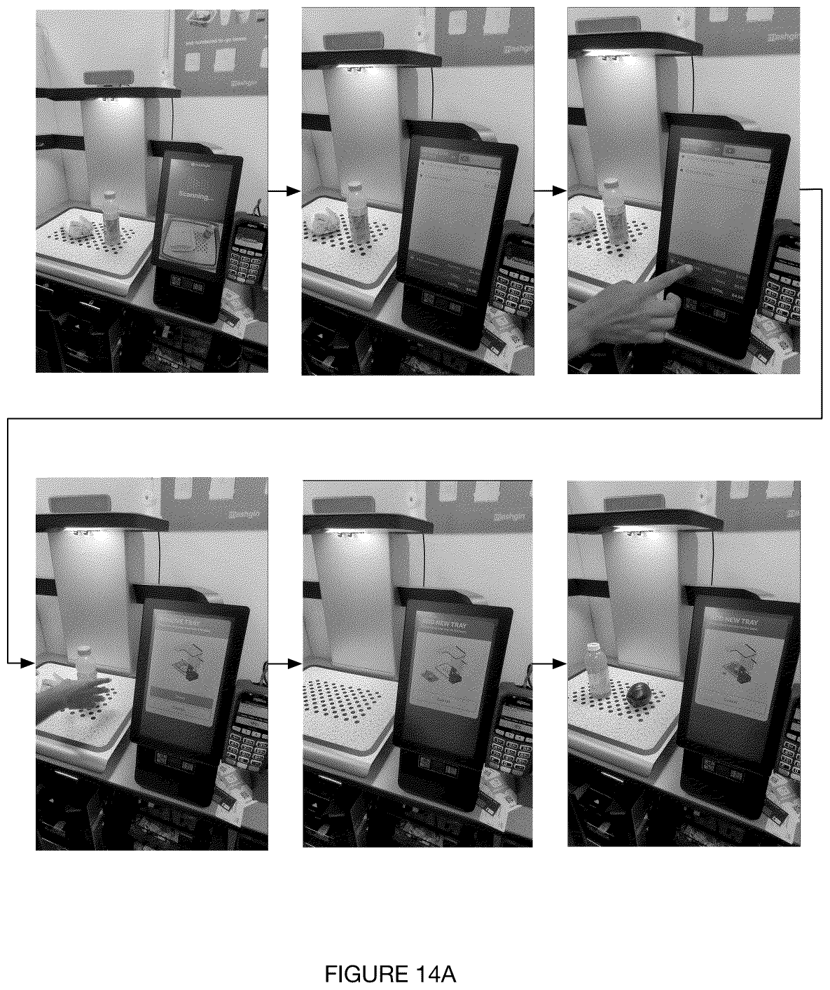

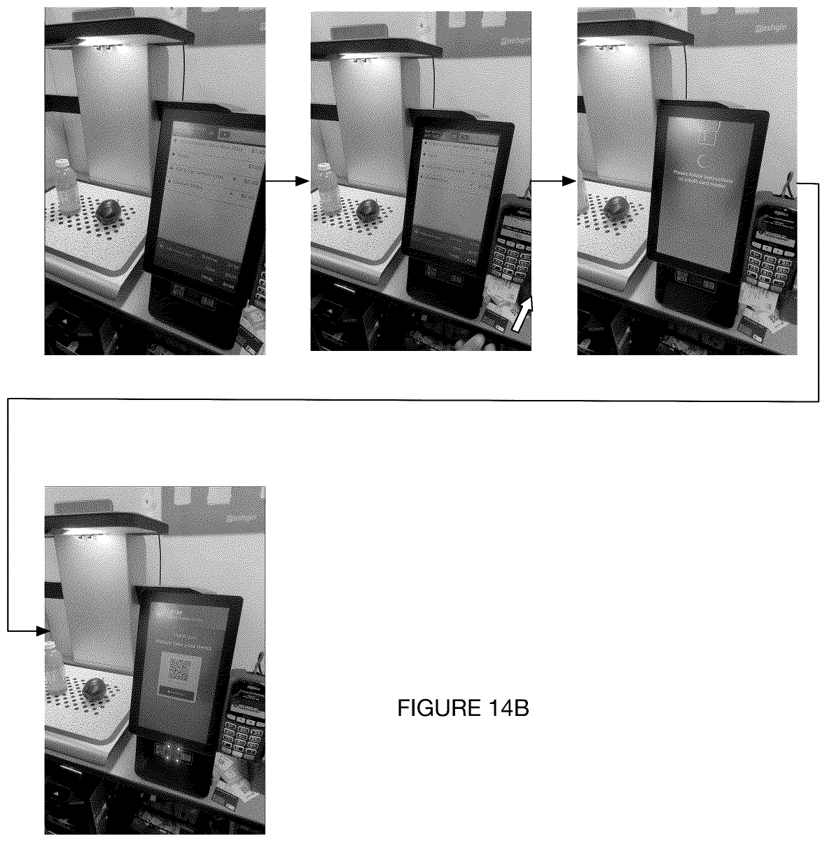

In a second example (e.g., examples shown in FIG. 13 and FIGS. 14A and 14B), the method includes: repeatedly capturing measurements of a batch of items (e.g., static items, at-rest items) within the measurement volume (e.g., static measurement volume) and identifying the items within the batch based on the measurements (e.g., based on the visual appearance of the items), for successive batches of items, until a checkout condition is met, after which the transaction for the one or more batches of items can be completed. In an illustrative example, this can include iteratively: identifying each item within a batch of items within the measurement volume, adding the identified items to an invoice for the checkout session, and prompting the user to pay or add additional items. When the user elects to pay, the system can receive payment information from the user and complete the transaction using the payment information. When the user elects to add more items, the system can prompt the user to remove the batch of items from the measurement volume, optionally verify that the items have been removed (e.g., using a weight sensor in the base, based on an analysis of the measurements of the measurement volume, etc.), and optionally prompt the user to add more items, wherein the method is repeated for the successive batch of items. Additionally or alternatively, the payment information can be received from the user before a successive batch of items is received within the measurement volume (e.g., the second batch, the last batch, etc.), and stored until the user elects to pay. In specific example, the users can contemporaneously place their items into the measurement volumes of multiple systems, wherein all items detected within a shared timeframe can be billed together. In another specific example, when a user is paying for multiple user's items (e.g., a parent paying for their family's trays of food), the users can sequentially (e.g., serially) place their items (e.g., their tray of food) into the measurement volume, wait for the items to be automatically detected and added to the bill, and remove their items (e.g., trays) after the items have been detected. The user can then pay for all the items (e.g., trays of food) after everyone has placed their items into the measurement volume. However, one or more batches of items can be otherwise invoiced and paid for.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

1. A self-checkout system comprising:
a set of downward-angled cameras mounted around a measurement volume; and
a processing system configured to:
a) concurrently acquire, from the set of downward-angled cameras, a set of two or more images of a batch of items, lacking semantic identifiers, within a measurement volume;
b) automatically identify each item within the batch based on a feature vector for the item extracted from the set of images using a trained model comprising a subset of layers of a neural network trained to categorize items, wherein identifying each item within the batch comprises:
comparing the feature vector for the item to each of a set of stored reference feature vectors, each corresponding to a stored semantic identifier; and
assigning a semantic identifier to the item, wherein the assigned semantic identifier corresponds to a stored reference feature vector with a smallest distance to the feature vector;
c) add billing information for the identified items to a bill;
d) repeat a)-c) for successive batches of items until a checkout condition is met; and
e) process payment for the bill after the checkout condition is met.

2. The self-checkout system of claim 1, wherein a batch comprises more than one item.

3. The self-checkout system of claim 1, wherein the semantic identifiers comprise at least one of a barcode, a QR code, or a UPC.

4. The self-checkout system of claim 1, wherein a preceding batch of items is removed from the measurement volume prior to placement of a next batch of items within the measurement volume, wherein the next batch of items is placed within the measurement volume before the checkout condition is met.

5. The self-checkout system of claim 1, wherein the batch of items is manually placed within the measurement volume.

6. The self-checkout system of claim 1, wherein the batch of items is static during image acquisition.

7. The self-checkout system of claim 1, wherein the measurement volume is defined by a static base, and wherein the measurement volume is static during a).

8. The self-checkout system of claim 1, further comprising receiving payment information before the set of images for a last batch of items is acquired, wherein e) is performed using the payment information.

9. The self-checkout system of claim 1, wherein the checkout condition comprises user selection of a checkout button.

10. The self-checkout system of claim 1, wherein each item is automatically identified based on a visual appearance of the item depicted in the set of images.

11. (canceled)

12. (canceled)

13. The self-checkout system of claim 10, wherein identifying each item based on a visual appearance of the respective item comprises:
generating a geometric representation of the batch of items based on the set of images;
determining an item mask for each item based on the geometric representation;
for each item, determining a set of item image segments from the set of images based on the respective item mask; and
identifying the item based on the set of item image segments.

14. The self-checkout system of claim 13, wherein identifying the item comprises determining an item class using a classifier trained using training images of the item labeled with the item class.

15. A system, comprising:
a static measurement volume defined by at least two open sides and a static base and configured to statically support items therein;
a set of downward-angled sensors statically mounted about the measurement volume, each configured to sample measurements of items within the measurement volume; and
a processing system configured to:
a) acquire a set of measurements of a batch of items concurrently arranged within the measurement volume from the downward-angled sensors, wherein the batch of items comprise more than one item;
b) automatically identify each item within the batch based on the set of measurements, wherein at least one identified item lacks a semantic identifier and wherein identifying each item comprises;
determining a feature vector for the item using a neural network;
comparing the feature vector for the item to each of a set of reference feature vectors, each associated with a semantic identifier; and
assigning the semantic identifier, associated with a reference feature in the set of reference feature vectors with a smallest distance to the feature vector for the item, to the item:
c) add billing information for the identified items to a bill;
d) when an addition condition is satisfied, repeat a)-c) for successive batches of items; and
e) when the addition condition is not satisfied, process payment for the bill.

16. The system of claim 15, wherein the addition condition comprises selection of a button to add more batches of items to the bill.

17. The system of claim 15, wherein payment information is received before a second batch of items is placed within the measurement volume.

18. The system of claim 15, wherein the item is identified based on a similarity metric between feature vectors extracted from measurement segments, determined from the set of measurements, that correspond to the item, and a set of reference feature vectors for a set of known item identifiers.

19. The system of claim 15, the items are identified using a neural network trained to predict the item identifier.

20. The system of claim 15, wherein payment is processed using a cash register.

21. A self-checkout system comprising:
a static base defining a static measurement volume;
a set of downward facing cameras statically arranged relative to the static base and the static measurement volume; and
a processing system configured to:
a) contemporaneously acquire a set of images of a batch of items, lacking semantic identifiers, from the set of downward facing cameras within the measurement volume;
b) extract a feature vector for each item from the set of images using a subset of layers from a neural network trained to predict an item class based on the set of images;
c) identify each item within the batch by comparing the respective feature vector to a set of reference feature vectors, each associated with a known semantic identifier, within a database;
c) add billing information for the identified items to a bill; and
e) process payment for the bill.

22. The self-checkout system of claim 21, wherein e) is performed after a checkout condition is met.
